(19) United States
(12) Patent Application Publication
(10) Pub. No.: US 2014/0307126 A1
(43) Pub. Date: Oct. 16, 2014

(54) ELECTRONIC APPARATUS AND METHOD OF CONTROLLING THE SAME

(71) Applicant: SAMSUNG ELECTRONICS CO., LTD., Suwon-si (KR)

(72) Inventors: Woo Ram Son, Seoul (KR); Su Jin Ryu, Suwon-si (KR)

(73) Assignee: SAMSUNG ELECTRONICS CO., LTD., Suwon-si (KR)

(21) Appl. No.: 14/250,579

(22) Filed: Apr. 11, 2014

(30) Foreign Application Priority Data
Apr. 12, 2013 (KR) 10-2013-0040454

(51) Int. Cl. H04N 5/232

(52) U.S. Cl. CPC H04N 5/23212
USPC 348/231.6; 348/348

(57) ABSTRACT

Disclosed herein are an electronic apparatus and a method of controlling the same. The electronic apparatus includes a photography lens that receives an optical signal from an object. The photography lens includes a focus lens. The electronic apparatus further includes a distance sensor that outputs image data based on the optical signal incident thereon through the photography lens and that outputs distance information. The electronic apparatus further includes a controller that calculates respective distance positions of the focus lens for one or more distances based on the distance information and that calculates respective contrast positions of the focus lens corresponding to the distance positions based on the image data and that corrects respective reference positions of the focus lens for the one or more distances.

### CROSS-REFERENCE TO RELATED APPLICATION(S)

This application claims the priority benefit under 35 U.S.C. §119(a) from Korean Patent Application No. 10-2013-0040454, filed on Apr. 12, 2013 in the Korean Intellectual Property Office, the disclosure of which is incorporated herein by reference in its entirety.

### BACKGROUND

1. Field

Embodiments of the present disclosure relate to an electronic apparatus and a method of controlling the same.

2. Related Art

Currently, an image sensor capable of simultaneously acquiring distance and color has been applied to a mobile display as well as a camera in various ways, in accordance with current trends. A camera including such an image sensor installed therein may perform auto focus (AF) using a distance from an object, obtained by a distance sensor.

AF using a contrast sensor, but not the aforementioned distance sensor, is performed by finding an optimum AF point while moving a focus lens forward or backward via a motor. On the other hand, AF using the distance sensor is performed by directly moving a focus lens to a point corresponding to a distance from an object, and thus, is performed at higher speed than in other AF using the contrast sensor. In addition, the AF using the distance sensor does not require additional instruments unlike in phase difference AF. However, in the AF using the distance sensor, AF errors may accumulate.

### SUMMARY

Various embodiments of the present disclosure provide an electronic apparatus and a method of controlling the same that automatically corrects a position of a focus lens of a distance sensor for each respective distance.

Additional embodiments will be set forth in part in the description which follows and, in part, will be apparent from the description, or may be learned by practice of the embodiments.

In accordance with one embodiment, an electronic apparatus includes a photography lens that receives an optical signal from an object. The photography lens includes a focus lens. The electronic apparatus further includes a distance sensor that outputs image data based on the optical signal incident thereon through the photography lens and that outputs distance information. The electronic apparatus further includes a controller that calculates respective distance positions of the focus lens for one or more distances based on the distance information and that calculates respective contrast positions of the focus lens corresponding to the distance positions based on the image data and that corrects respective reference positions of the focus lens for the one or more distances.

The controller may include a self-correction mode driver that executes a self-correction mode based on a user selection; a depth auto focus (AF) detector that calculates the distance positions of the focus lens from the distance information output from the distance sensor; a contrast AF detector that calculates the contrast positions of the focus lens from the image data output from the distance sensor; an error detector that extracts one or more representative regions, corresponding to the one or more distances, from the image data and that calculates a respective correction value for the distance positions of the focus lens based on the distance positions of the focus lens and the contrast positions of the focus lens for the corresponding representative region; and a pin calibrator that updates information regarding the reference positions based on the correction values of for the distance positions of the focus lens, calculated by the error detector.

The error detector may include a representative distance region extractor that extracts the one or more representative regions corresponding to the one or more distances from the image data output from the distance sensor; and an error determination unit that compares, for each distance of the one or more distances, the distance position of the focus lens and the contrast position of the focus lens with respect to the representative region and that determines a difference therebetween to calculate the corresponding correction value.

The representative distance region extractor may check a pre-stored history regarding extraction of representative regions for respective distances and extracts a representative region for a distance at a point of time when a preset reference time elapses.

The error determination unit may apply interpolation to the distance position and contrast position for each distance of the one or more distances to calculate a correction value for a distance position of the focus lens for a distance of a region other than the one or more representative regions.

The self-correction mode driver may execute the self-correction mode based on a user selection of a self-correction mode conversion key or a self-correction mode conversion menu.

The self-correction mode driver may limit execution of the self-correction mode when illumination of the image data output from the distance sensor is equal to or less than a preset low reference illumination or a contrast recognizable reference illumination.

The distance sensor may include an RGB data extractor that extracts RGB image data from a captured image; and a distance map extractor that extracts a distance map that includes the distance information for each respective pixel of the captured image.

The distance AF detector may calculate the distance positions of the focus lens based on the distance map and the respective reference positions of the focus lens for the one or more distances.

The contrast AF detector may calculate the contrast positions of the focus lens for each respective pixel of the RGB image data based on a preset second reference for determination of the position of the focus lens.

The electronic apparatus may further include a memory that stores information related to the electronic apparatus in addition to information regarding the reference positions of the focus lens for the one or more distances.

In accordance with another embodiment, a method of controlling an electronic apparatus includes: executing a self-correction mode based on a user selection; extracting one or more representative regions that correspond to one or more distances from image data output from a distance sensor; and correcting one or more distance positions of a focus lens using the one or more distance positions of the focus lens and one or more corresponding contrast positions of the focus lens with respect to the representative regions for the one or more distances.

The method may further include: calculating a first distance position of the one or more distance positions of the focus lens ,for a first distance of the one or more distances, based on the corresponding representative region for the first distance; calculating a first contrast position of the one or more contrast positions of the focus lens based on the corresponding representative region for the first distance; comparing the first distance position and the first contrast position to check whether a difference therebetween is present; calculating the difference between the first distance position of the focus lens and the first contrast position of the focus lens as a correction value for the first distance position of the focus lens when the difference is present, as a result of the check; and updating a reference position of the focus lens that corresponds to the first distance based on the correction value of the first distance position of the focus lens.

Calculating the first distance position may include: extracting a distance map that includes distance information of an object for each respective pixel from a captured image; and calculating the first distance position of the focus lens from the distance map based on a preset first reference for determination of the position of the focus lens.

The method may further include extracting RGB image data from a captured image prior to the calculation of the first contrast position of the focus lens.

Calculation of the first contrast position of the focus lens may include calculating the first contrast position of the focus lens from the RGB image data based on a preset second reference for determination of the position of the focus lens.

The method may further include applying interpolation to the one or more distance positions and one or more contrast positions to calculate a correction value for a distance position of the focus lens for a distance of a region other than the one or more representative regions, after the calculation of the correction value for the first distance position of the focus lens.

The correction of the one or more distance positions of the focus lens may be repeated for each representative region of the one or more representative regions.

The method may further include limiting execution of the self-correction mode when illumination of the image data output from the distance sensor is equal to or less than a preset low reference illumination or a contrast recognizable reference illumination, prior to the execution of the self-correction mode.

The extracting of the one or more representative regions may include checking a pre-stored history regarding extraction of representative regions for respective distances and extracting a representative region for a distance at a point of time when a preset reference time elapses.

### BRIEF DESCRIPTION OF THE DRAWINGS

These and/or other aspects of the embodiments will become apparent and more readily appreciated from the following description of the embodiments, taken in conjunction with the accompanying drawings of which:

FIG. 1 is a block diagram of an image processing apparatus according to an embodiment;

FIG. 2 is a block diagram of a portion of an instance of the image processing apparatus illustrated in FIG. 1;

FIG. 3 is a block diagram illustrating a structure of a distance sensor of the image processing apparatus illustrated in FIG. 2;

FIG. 4 is a block diagram illustrating a structure of an error detector of the image processing apparatus of FIG. 2;

FIGS. 5 to 7 are diagrams for explanation of a method of extracting a representative region for respective distances according to an embodiment;

FIG. 8 is a diagram for explanation of a method of calculating a correction value of a position of a focus lens for respective distances according to an embodiment; and

FIG. 9 is a flowchart of a method of controlling an image processing apparatus according to an embodiment.

### DETAILED DESCRIPTION

Exemplary embodiments will now be described more fully with reference to the accompanying drawings to clarify aspects, features and advantages of the various embodiments. In the drawings, the same elements are denoted by the same reference numerals. In the description, certain detailed explanations of related art are omitted when it is deemed that they may unnecessarily obscure the description of the embodiments. It will be understood that, although the terms first, second, etc. may be used herein to distinguish one element from another element, these elements should not be limited by these terms.

Reference will now be made to the embodiments, examples of which are illustrated in the accompanying drawings.

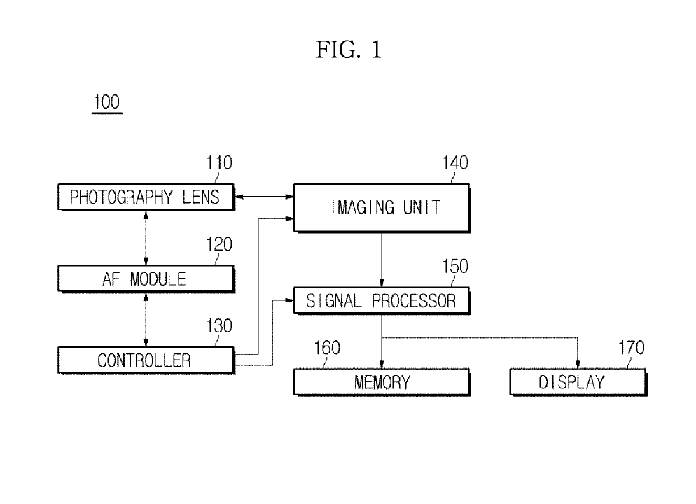

FIG. 1 is a block diagram of an electronic apparatus, such as an image processing apparatus 100, according to an embodiment.

As illustrated in FIG. 1, the image processing apparatus 100 may include a photography lens 110, an auto focus (AF) module 120, a controller 130, an imaging unit 140, a signal processor 150, a memory 160, and a display 170.

In more detail, the photography lens 110 receives an optical signal from an object and may include one or more of a zoom lens (not shown) to enlarge or reduce a displayed size of the object, a focus lens (not shown) to adjust a focal point of the object, and an iris or filter to adjust an amount of light from the object.

The AF module 120 may detect a focal point of the object to be photographed, under control of the controller 130, and may move the photography lens 110 (e.g., the focus lens) to focus the image processing apparatus 100 on the object.

The controller 130 may determine a position of the focus lens based on a distance to the object and a position of the focus lens based on image data output from the AF module 120, which will be described below.

The imaging unit 140 may be an imaging device to convert an optical signal of the object, incident thereon through the photography lens 110, into an electrical signal and to output the electrical signal.

The image processor 150 may perform signal processing such as gain adjustment, noise removal, gamma correction, luminance signal separation, image signal compression, etc. on the electrical signal output from the imaging unit 140. The image processor 150 may store a signal-processed image in the memory 160 and display the image on the display 170. In this case, the display 170 may be a viewfinder.

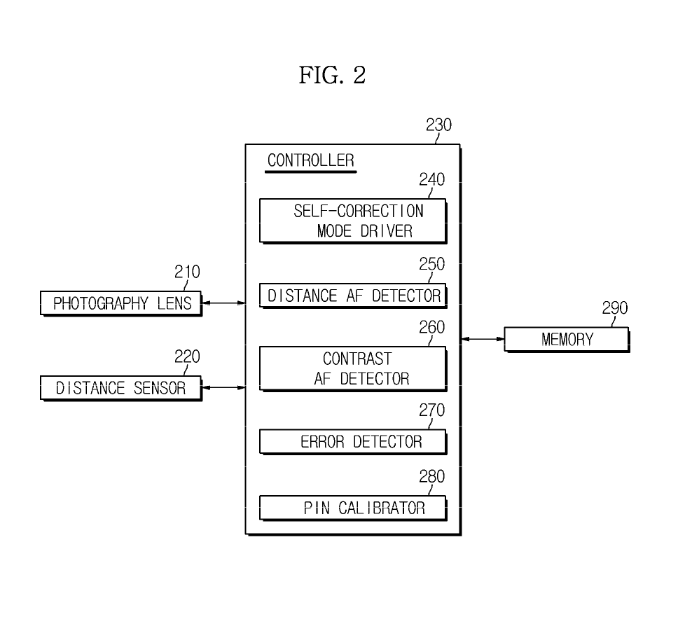

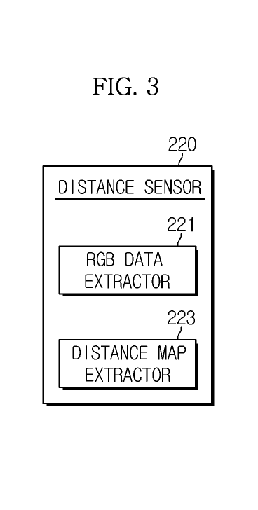

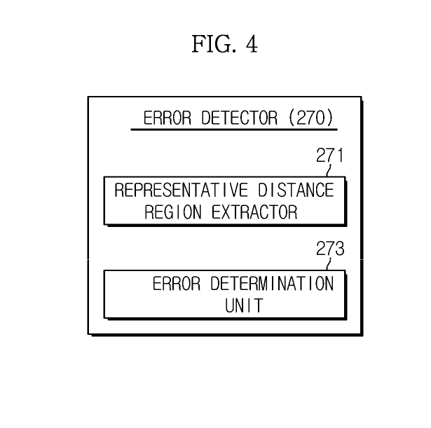

FIG. 2 is a block diagram of a portion of an instance of the image processing apparatus 100 illustrated in FIG. 1. FIG. 3 is a block diagram illustrating a structure of a distance sensor illustrated in FIG. 2. FIG. 4 is a block diagram illustrating a structure of an error detector of FIG. 2.

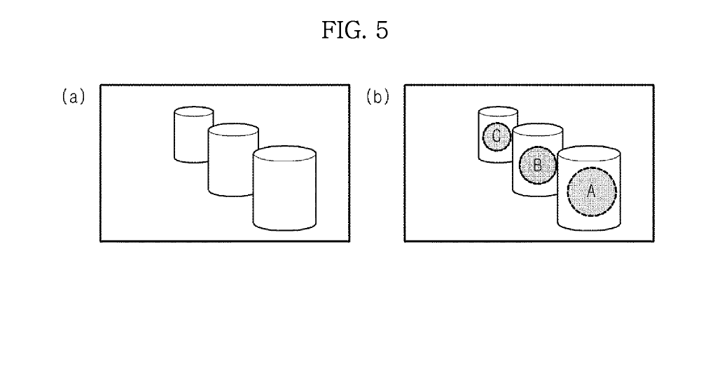

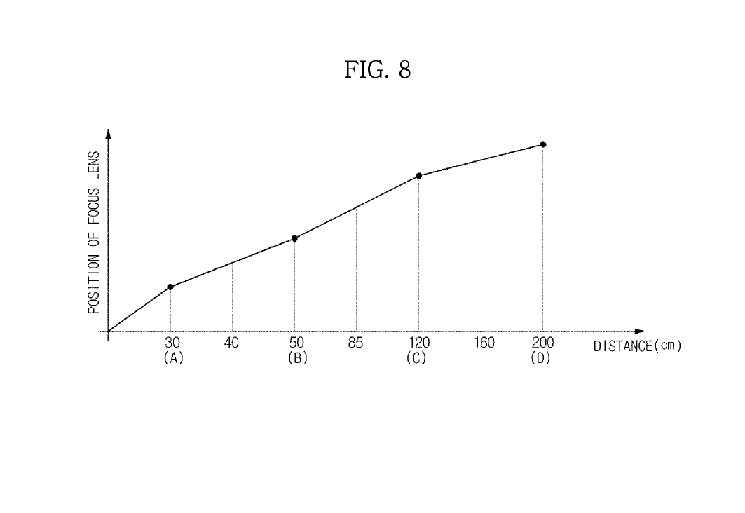

Along with FIGS. 2 through 4, a method of extracting a representative region for respective distances will be described with reference to FIGS. 5 through 7 and a method of calculating a correction value for a position of the focus lens for respective distances will be described with reference to FIG. 8.

As illustrated in FIG. 2, the image processing apparatus 100 may include a photography lens 210, a distance sensor 220, a controller 230, and a memory 290. In this case, the controller 230 may include a self-correction mode driver 240, a distance AF detector 250, a contrast AF detector 260, an error detector 270, and a pin calibrator 280.

In more detail, the photography lens 210 may receive an optical signal from an object.

The distance sensor 220 may output image data based on the optical signal incident thereon through the photography lens 210 and measure delay time until a pulse signal, emitted from a source (not shown) of the distance sensor 220 towards the object, returns from the object. The distance sensor 220 calculates a distance between the distance sensor 220 and the object based on time of flight (TOF) of the pulse signal. In this case, the signal output from the source of the distance sensor 220 may correspond to microwaves, light, ultrasonic waves, etc.

In order to calculate the distance to the object based on TOF, the distance sensor 220 may use a plurality of frame signals measured with different phase differences. For example, a distance sensor 220 having a 4-tap pixel structure may apply gate signals which simultaneously have phase differences of 0, 90, 180, and 270 degrees to a distance pixel and simultaneously extract a plurality of frame signals from a pulse signal reflected from the object to calculate the distance to the object. In addition, a distance sensor 220 using a distance pixel having a 1-tap pixel structure or 2-tap pixel structure may apply gate signals which have phase differences of 0, 90, 180, and 270 degrees at time intervals to the distance pixel and calculate the distance to the object using a plurality of frame signals measured at time intervals.

In more detail, as illustrated in FIG. 3, the distance sensor 220 may include an RGB data extractor 221 and a distance map extractor 223.

The RGB data extractor 221 may extract RGB image data from a captured image. In this case, the RGB image data may include RGB information for one or more respective pixels. In a further example, the RGB image data may include RGB information for each respective pixel.

The distance map extractor 223 may extract a distance map including distance information of the object for one or more pixels (or each pixel) from the captured image. In this case, the distance map may include distance information for the respective pixels.

The controller 230 may calculate a position of the focus lens (e.g., a distance position) based on the distance to the object (e.g., by the distance AF detector 250 with the distance map) and a position of the focus lens (e.g., a contrast position) based on the contrast AF detector 260 from the image data output from the distance sensor 220 to correct a corresponding reference position of the focus lens for the distance AF detector 250 for one or more respective distances (or each distance) of the distance map.

As illustrated in FIG. 2, the controller 230 may include the self-correction mode driver 240, the distance AF detector 250, the contrast AF detector 260, an error detector 270, and the pin calibrator 280.

The self-correction mode driver 240 may execute a self-correction mode based on a user selection. Although not illustrated, the image processing apparatus 100 may include, but is not limited to, a self-correction mode conversion key or self-correction mode conversion menu to execute the self-correction mode. Thus, the self-correction mode driver 240 may receive a request input based on the user selection of the self-correction mode conversion key or the self-correction mode conversion menu and execute the self-correction mode. In this case, the self-correction mode may refer to a mode to correct the reference position of the focus lens for the distance AF detector 250.

When illumination of the image data output from the distance sensor 220 is equal to or less than a preset low reference illumination (e.g., corresponding to the distance AF detector 250) or a contrast recognizable reference illumination (e.g., corresponding to the contrast AF detector 260), the self-correction mode driver 240 may limit execution of the self-correction mode. For example, when the illumination of the image data output from the distance sensor 220 is equal to or less than the preset low reference illumination, the self-correction mode driver 240 determines that it is difficult to correct the reference position of the focus lens through the acquired image data and limits conversion to the self-correction mode. In this case, the low reference illumination may be manually set, but the embodiments are not limited thereto.

In addition, when the illumination of the image data output from the distance sensor 220 is equal to or less than the contrast recognizable reference illumination, the self-correction mode driver 240 determines that it is difficult to recognize contrast from the image data (e.g., via the contrast AF detector 260) and thus correction is not possible, and does not perform self-correction mode conversion although a request for self-correction mode conversion has been input by the user. For example, when it is difficult to recognize contrast by the contrast AF detector 260, the obtained image data may be image data of a single color object, but embodiments are not limited thereto. In this case, the image processing apparatus 100 may indicate failure in self-correction mode conversion through a separate display, that is, the display 170 such that the user may recognize such failure.

In addition, whether the self-correction mode driver 240 is capable of determination of contrast is determined through the contrast AF detector 260.

The distance AF detector 250 may calculate the distance position of the focus lens based on the distance map output from the distance sensor 220 and corresponding reference position of the focus lens for the distance AF detector 250. The distance AF detector 250 may calculate the distance position of the focus lens for each respective distance from the distance map based on the corresponding reference position, for example, a preset first reference for determination of the position of the focus lens.

In this case, the preset first reference for determination of the position of the focus lens may refer to a reference for calculation of the distance position of the focus lens based on the distance map that includes distance information for each respective pixel.

The contrast AF detector 260 may calculate the contrast position of the focus lens based on the image data output from the distance sensor 220.

The contrast AF detector 260 may calculate the contrast position of the focus lens for each respective pixel from RGB image data output from the RGB data extractor 221 based on a preset second reference for determination of a contrast position of a focus lens. In this case, the preset second reference for determination of the position of the focus lens may refer to a reference for calculation of the position of the focus lens during contrast AF based on RGB image data.

The contrast AF detector 260 may extract a high frequency component, extracted from an image signal, as an AF estimation value by a filter with a band for determination of AF. The contrast AF detector 260 may adjust focus by controlling and moving the focus lens forward or backward to maximize the contrast AF estimation value. That is, when the object is photographed, the position of the focus lens having a maximum contrast AF estimation value is a general in-focus point.

When the contrast AF detector 260 is able to determine the position of the focus lens from the RGB image data output from the distance sensor 220 in the image processing apparatus 100, the contrast AF detector 260 may be configured in the form of software without any separate hardware configuration (e.g., executed by the controller 230), but is not limited thereto. Alternatively, the contrast AF detector 260 may be configured in the form of separate hardware according to needs of an operator or manufacturer.

The error detector 270 may extract a representative region for each respective distance from image data output from the distance sensor 220. The error detector 270 calculates a corresponding correction value for the distance position of the focus lens from the distance AF detector 250, for each respective distance, based on the distance position of the focus lens determined by the distance AF detector 250 for the extracted representative region and the contrast position of the focus lens determined by the contrast AF detector 260.

According to an embodiment, in order to correct the reference position of the focus lens for the distance AF detector 250, the correction value may be calculated via a comparison based on the contrast position of the focus lens determined by the contrast AF detector 260 having generally higher accuracy than the distance position of the focus lens determined by the distance AF detector 250.

As illustrated in FIG. 4, the error detector 270 may include a representative distance region extractor 271 and an error determination unit 273.

The representative distance region extractor 271 may extract a plurality of representative regions for respective distances from the image data output from the distance sensor 220. For example, as illustrated in FIG. 5, the representative distance region extractor 271 may separate object images from first image data (FIG. 5(A)) output from the distance sensor 220 and extract representative regions (A, B, and C of FIG. 5(B)) for respective distances.

In this case, the image data output from the distance sensor 220 includes distance information of the object, and thus, the representative distance region extractor 271 may extract a representative region for each respective distance based on the distance information of the object.

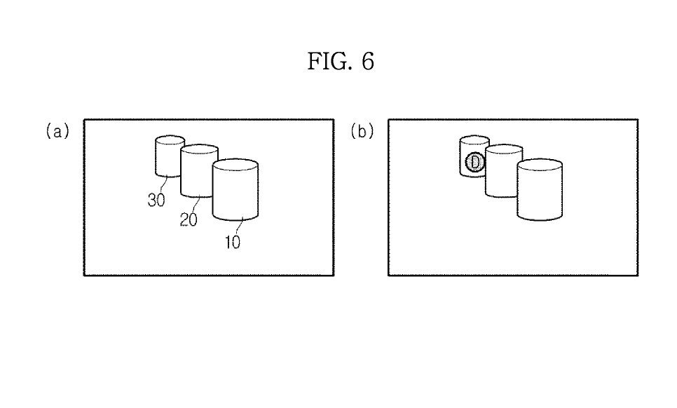

In addition, as illustrated in FIG. 6, the representative distance region extractor 271 may further extract a representative region for each respective distance, such as D of FIG. 6(b), from second image data (FIG. 6(a)) that includes objects 10, 20, and 30.

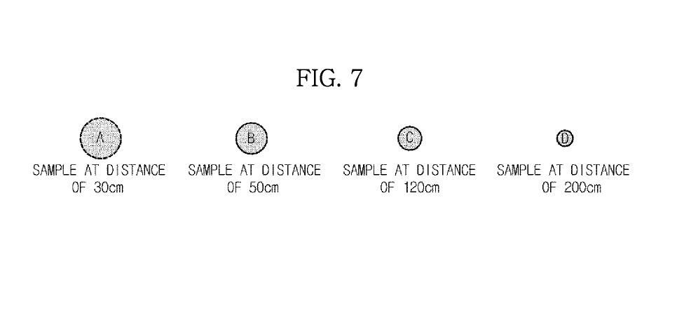

Through the aforementioned processes, the representative distance region extractor 271 may extract the representative regions A, B, C, and D for respective distances of 30 cm, 50 cm, 120 cm, and 200 cm, as illustrated in FIG. 7.

The representative distance region extractor 271 may correct the position of the focus lens to various distances by extracting representative regions at various distances, thereby improving the reliability of image processing. Thus, photography is performed a plurality of times for self-correction so as to extract a plurality of representative regions for distances.

In this case, photography for the self-correction mode may be performed a number of times set by an operator or manufacturer. However, the embodiments are not limited thereto. Alternatively, the photography for the self-correction mode may be performed a number of times set by a user in real time.

When the representative distance region extractor 271 extracts a plurality of representative regions for corresponding distances from image data, the representative distance region extractor 271 may check a pre-stored history regarding extraction of representative regions for respective distances and extract a representative region for a distance at a point of time when a preset reference time elapses from a prior extraction at that distance. In this case, the history regarding extraction of representative regions for respective distances may indicate a distance at which a representative region is extracted and a time when a representative region for a corresponding distance was last extracted. However, the embodiments are not limited thereto. Alternatively, the history may contain additional information regarding a representative region according to needs of an operator.

That is, when the representative distance region extractor 271 extracts representative regions for respective distances from one image or a plurality of images, the representative distance region extractor 271 may set the reference time to extract the representative regions for respective distances and extract a representative region for a distance at a point of time when the reference time elapses in order to prevent a representative region that has already been corrected or representative regions for the same distance from being redundantly extracted.

For example, where the image of FIG. 5(A) is first photography image data for self-correction, an image of FIG. 6(A) is second photography image data, and objects 10 and 20 of FIG. 6(A) are regions B and C of FIG. 5(B), respectively, the representative distance region extractor 271 may extract only an object 30 of FIG. 6(A) as a representative region D.

When the same object as an object of a first photography image is present with objects of a second photography image and second photography is performed just after first photography such that the reference time has not elapsed, the corresponding object is excluded from a representative region.

Thus, the image processing apparatus 100 may reduce time taken to correct the position of the focus lens and extract representative regions for more various distances, thereby improving the reliability of image processing results.

The error determination unit 273 may compare the distance position of the focus lens determined by the distance AF detector 250 and the contrast position of the focus lens determined by the contrast AF detector 260 with respect to representative regions for respective distances and determine a difference therebetween to calculate a correction value for the distance position of the focus lens for each respective distance.

In addition, the error determination unit 273 may apply interpolation to the distance position and contrast position of the focus lens for each distance corresponding to the representative regions to calculate a correction value for a distance position of the focus lens for a distance of a region other than representative regions. In this case, correction values of the portions of the regions corresponding to distances that are not extracted as representative regions by the representative distance region extractor 271 may be calculated based on the position of the focus lens, extracted as the representative region.

For example, as illustrated in FIG. 8, when distances of representative regions (A, B, C, and D of FIG. 7) extracted by the representative distance region extractor 271 are 30 cm, 50 cm, 120 cm, and 200 cm, the error determination unit 273 compares the distance position of the focus lens determined by the distance AF detector 250 for the respective distances of 30 cm, 50 cm, 120 cm, and 200 cm and the corresponding contrast positions of the focus lens determined by the contrast AF detector 260 to calculate correction values for the distance positions of the focus lens for respective distances.

In addition, a correction value for a distance position of the focus lens for a distance of 40 cm, a representative region of which is not extracted by the representative distance region extractor 271, may be calculated from an average value of correction values for positions of the focus lens for distances of 30 cm and 50 cm. A correction value for a distance position of the focus lens for a distance of 85 cm may be calculated from an average value of correction values for positions of the focus lens for distances of 50 cm and 120 cm. In addition, a correction value for a distance position of the focus lens for a distance of 160 cm may be calculated from an average value of correction values for positions of the focus lens for distances of 120 cm and 200 cm. In these cases, numbers illustrated in FIG. 8 are merely examples, and thus, the embodiments are not limited thereto.

The pin calibrator 280 may update information regarding a reference position of the focus lens for the distance AF detector 250 for each respective distance based on correction values for positions of the focus lens for respective distances, calculated by the error detector 270.

In this case, the reference position of the focus lens for the distance AF detector 250 for each respective distance may refer to a reference position to which the focus lens needs to be moved based on a distance from the object to the image processing apparatus 100. In addition, the reference position may be a position to which the focus lens is moved by a motor configured to move the focus lens.

The memory 290 may store information related to the image processing apparatus 100 in addition to information regarding the reference positions of the focus lens for each respective distance.

The image processing apparatus 100 according to the embodiments may be, but is not limited to, a digital camera, a digital camcorder, a cellular phone including a camera installed therein, a notebook computer, a personal digital assistant (PDA), or a portable multimedia player (PMP). In addition, the image processing apparatus may be any apparatus as long as the apparatus photographs an object to acquire an image and uses a distance sensor.

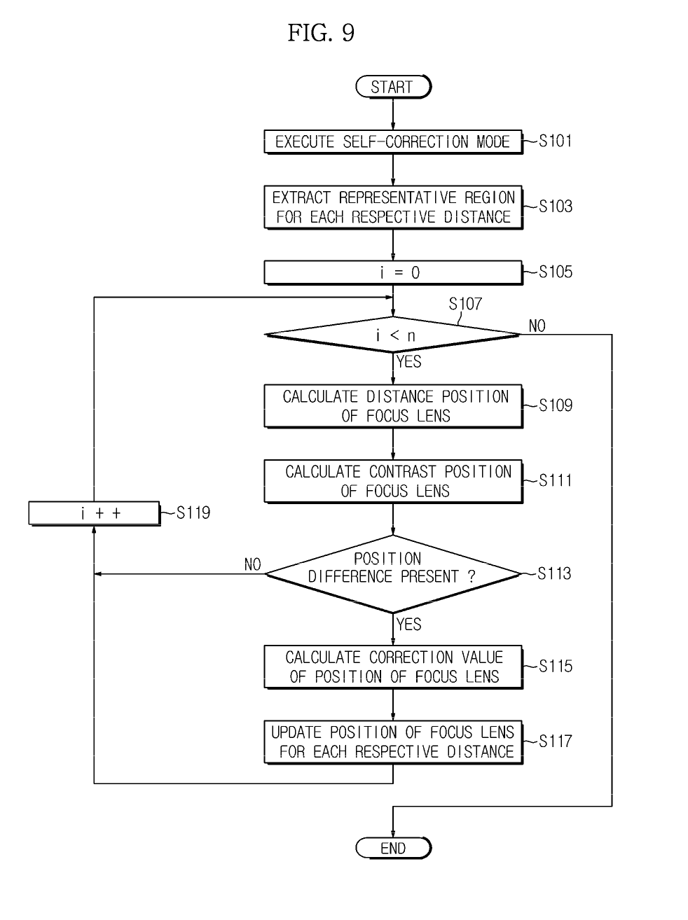

FIG. 9 is a flowchart of a method of controlling the image processing apparatus 100, according to an embodiment.

First, the image processing apparatus 100 may execute a self-correction mode based on a user selection (S101). In this case, based on the user selection of the self-correction mode conversion key (not shown) or the self-correction mode conversion menu (not shown), the image processing apparatus 100 may execute the self-correction mode.

Although not illustrated, prior to executing the self-correction mode of operation S101, the image processing apparatus 100 limits execution of the self-correction mode when illumination of the image data output from the distance sensor 220 is equal to or less than preset low reference illumination or contrast recognizable reference illumination.

For example, when the illumination of the image data output from the distance sensor 220 is equal to or less than the preset low reference illumination, the image processing apparatus 100 determines that it is difficult to correct the position of the focus lens through the acquired image data and limits conversion to the self-correction mode. In this case, the low reference illumination may be manually set by an operator, but embodiments are not limited thereto.

In addition, when the illumination of the image data output from the distance sensor 220 is equal to or less than the contrast recognizable reference illumination, the image processing apparatus 100 determines that it is difficult to recognize contrast from the image data and thus correction is not possible, and does not perform self-correction mode conversion although a request for self-correction mode conversion is input by the user. For example, when it is difficult to recognize contrast, the obtained image data may be a single color object, but embodiments are not limited thereto.

Then, the image processing apparatus 100 may extract representative regions for a plurality of distances from image data output from the distance sensor 220 (S103).

When the image processing apparatus 100 extracts a plurality of representative regions for distances from image data, the image processing apparatus 100 may check a pre-stored history regarding extraction of representative regions for respective distances and extract a representative region for a distance at a point of time when a preset reference time elapses. In this case, the image processing apparatus 100 may extract representative regions for respective distances and store related information as the history regarding extraction of representative regions for respective distances.

Then, the image processing apparatus 100 may correct the distance position of the focus lens of the distance sensor 220 for each respective distance using the distance position of the focus lens of the distance sensor 220 and the contrast position of the focus lens with respect to representative regions for respective distances.

When representative regions for respective distances are extracted in operation S103, the image processing apparatus 100 may calculate the distance position of the focus lens by the distance AF detector 250 for representative regions for specific distances from representative regions for a plurality of distances (S105 to S109).

In this case, a value i of operation S105 may refer to a reference count to perform a correction process after self-correction mode conversion and extraction of representative regions for each respective distance and a value n of operation S107 may refer to a number of extracted representative regions.

In addition, the calculation of the distance position of the focus lens by the distance AF detector 250 in operation S109 may include extracting a distance map containing distance information of an object for each respective pixel from a captured image, and calculating the distance position of the focus lens by the distance AF detector 250 for each respective pixel from the distance map based on a preset first reference for determination of a position of the focus lens.

In this case, the first reference for determination of the position of the focus lens may refer to a reference to determine the position of the focus lens by the distance AF detector 250 from the distance map that includes distance information for each respective pixel.

Then, the image processing apparatus 100 may determine the contrast position of the focus lens based on the contrast AF detector 260 for representative regions for specific distances (S111).

Prior to the calculation of the contrast position of the focus lens by the contrast AF detector 260 in operation S111, the image processing apparatus 100 may extract RGB image data from a captured image.

Then, in operation S111, the contrast position of the focus lens for each respective pixel may be determined by the contrast AF detector 260 based on the RGB image data based on a preset second reference for determination of a position of the focus lens.

In this case, the second reference for determination of the position of the focus lens may refer to a reference to determine the position of the focus lens during contrast AF based on RGB image data.

Then, the image processing apparatus 100 may compare the distance position of the focus lens determined by the distance AF detector 250 and the contrast position of the focus lens determined by the contrast AF detector 260 to determine whether a difference therebetween is present (S113).

As a result of the determination (S113), when the difference is present (YES at S113), the image processing apparatus 100 may calculate a correction value (S115) as the difference between the contrast position of the focus lens determined by the contrast AF detector 260 and the distance position of the focus lens determined by the distance AF detector 250.

When the difference between the contrast position of the focus lens determined by the contrast AF detector 260 and the distance position of the focus lens determined by the distance AF detector 250 is not present (NO at S113), the image processing apparatus 100 may perform operation S119 to perform the correction process on a next representative region from representative regions for a plurality of distances.

That is, operation S109, of calculating the correction value for the distance position of the focus lens determined by the distance AF detector 250 for each respective distance, through operation S117, of updating the reference position of the focus lens for the distance AF detector 250 for each respective distance, are repeated by the number n of the extracted representative regions.

Thus, the image processing apparatus 100 may update the reference position of the focus lens for the distance AF detector 250 for each respective distance based on the correction value for the position of the focus lens (S117).

In this case, the reference position of the focus lens for the distance AF detector 250 for each respective distance may refer to a reference position to which the focus lens needs to be moved based on a distance from the object in the image processing apparatus 100. In addition, the reference position may be a position to which the focus lens is moved by a motor configured to move the focus lens.

Then, the image processing apparatus 100 may perform operation S119 and perform the correction process on a next representative region from representative regions for a plurality of distances.

As a result of the check of operation S107, when the reference count i is not less than the number of representative regions (NO at S107), the image processing apparatus 100 may determine that correction of representative regions for all distances has been completed and complete the self-correction process.

After the calculation of the correction value for the position of the focus lens in operation S115, the image processing apparatus 100 may apply interpolation to the distance position and contrast position of the focus lens for each distance corresponding to the representative regions to calculate a correction value for a distance position of the focus lens for a distance of a region other than representative regions.

The image processing apparatus according to the embodiments may have both advantages of contrast AF and phase difference AF, and simultaneously, prevent accumulation of AF errors via a self-correction mode, thereby improving the reliability of AF results.

As is apparent from the above description, an image processing apparatus and a method of controlling the same may automatically correct a position of a focus lens of a distance sensor for each respective distance to prevent error accumulation of a motor of the focus lens, thereby improving the reliability of AF results of the distance sensor.

Although a few embodiments have been shown and described, it would be appreciated by those skilled in the art that changes may be made in these embodiments without departing from the principles and spirit of the invention, the scope of which is defined in the claims and their equivalents.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. An electronic apparatus comprising:
a photography lens that receives an optical signal from an object, wherein the photography lens includes a focus lens;
a distance sensor that outputs image data based on the optical signal incident thereon through the photography lens and outputs distance information; and
a controller that calculates respective distance positions of the focus lens for one or more distances based on the distance information and that calculates respective contrast positions of the focus lens corresponding to the distance positions based on the image data and that corrects respective reference positions of the focus lens for the one or more distances.

2. The electronic apparatus according to claim 1, wherein the controller comprises:
a self-correction mode driver that executes a self-correction mode based on a user selection;
a depth auto focus (AF) detector that calculates the distance positions of the focus lens from the distance information output from the distance sensor;
a contrast AF detector that calculates the contrast positions of the focus lens from the image data output from the distance sensor;
an error detector that extracts one or more representative regions, corresponding to the one or more distances, from the image data and that calculates a respective correction value for the distance positions of the focus lens based on the distance positions of the focus lens and the contrast positions of the focus lens for the corresponding representative region; and
a pin calibrator that updates information regarding the reference positions based on the correction values of for the distance positions of the focus lens, calculated by the error detector.

3. The electronic apparatus according to claim 2, wherein the error detector comprises:
a representative distance region extractor that extracts the one or more representative regions corresponding to the one or more distances from the image data output from the distance sensor; and
an error determination unit that compares, for each distance of the one or more distances, the distance position of the focus lens and the contrast position of the focus lens with respect to the representative region and that determines a difference therebetween to calculate the corresponding correction value.

4. The electronic apparatus according to claim 3, wherein the representative distance region extractor checks a pre-stored history regarding extraction of representative regions for respective distances and extracts a representative region for a distance at a point of time when a preset reference time elapses.

5. The electronic apparatus according to claim 3, wherein the error determination unit applies interpolation to the distance position and contrast position for each distance of the one or more distances to calculate a correction value for a distance position of the focus lens for a distance of a region other than the one or more representative regions.

6. The electronic apparatus according to claim 2,
wherein the self-correction mode driver executes the self-correction mode based on a user selection of a self-correction mode conversion key or a self-correction mode conversion menu.

7. The electronic apparatus according to claim 2, wherein the self-correction mode driver limits execution of the self-correction mode when illumination of the image data output from the distance sensor is equal to or less than a preset low reference illumination or a contrast recognizable reference illumination.

8. The electronic apparatus according to claim 2, wherein the distance sensor comprises:
an RGB data extractor that extracts RGB image data from a captured image; and
a distance map extractor that extracts a distance map that includes the distance information for each respective pixel of the captured image.

9. The electronic apparatus according to claim 8, wherein the distance AF detector calculates the distance positions of the focus lens based on the distance map and the respective reference positions of the focus lens for the one or more distances.

10. The electronic apparatus according to claim 8, wherein the contrast AF detector calculates the contrast positions of the focus lens for each respective pixel of the RGB image data based on a preset second reference for determination of the position of the focus lens.

11. The electronic apparatus according to claim 2, further comprising a memory that stores information related to the electronic apparatus in addition to information regarding the reference positions of the focus lens for the one or more distances.

12. A method of controlling an electronic apparatus, the method comprising:
executing a self-correction mode based on a user selection;
extracting one or more representative regions that correspond to one or more distances from image data output from a distance sensor; and
correcting one or more distance positions of a focus lens using the one or more distance positions of the focus lens and one or more corresponding contrast positions of the focus lens with respect to the representative regions for the one or more distances.

13. The method according to claim 12, wherein the correcting comprises:
calculating a first distance position of the one or more distance positions of the focus lens, for a first distance of the one or more distances, based on the corresponding representative region for the first distance;
calculating a first contrast position of the one or more contrast positions of the focus lens based on the corresponding representative region for the first distance;
comparing the first distance position and the first contrast position to check whether a difference therebetween is present;
calculating the difference between the first distance position of the focus lens and the first contrast position of the focus lens as a correction value for the first distance position of the focus lens when the difference is present, as a result of the check; and
updating a reference position of the focus lens that corresponds to the first distance based on the correction value of the first distance position of the focus lens.

14. The method according to 13, wherein the calculating of the first distance position of the focus lens comprises:
extracting a distance map that includes distance information of an object for each respective pixel from a captured image; and
calculating the first distance position of the focus lens from the distance map based on a preset first reference for determination of the position of the focus lens.

15. The method according to 13, further comprising extracting RGB image data from a captured image prior to the calculation of the first contrast position of the focus lens.

16. The method according to 15, wherein the calculation of the first contrast position of the focus lens comprises calculating the first contrast position of the focus lens from the RGB image data based on a preset second reference for determination of the position of the focus lens.

17. The method according to 13, further comprising:
applying interpolation to the one or more distance positions and one or more contrast positions to calculate a correction value for a distance position of the focus lens for a distance of a region other than the one or more representative regions, after the calculation of the correction value for the first distance position of the focus lens.

18. The method according to 12, wherein the correction of the one or more distance positions of the focus lens is repeated for each representative region of the one or more representative regions.

19. The method according to 12, further comprising:
limiting execution of the self-correction mode when illumination of the image data output from the distance sensor is equal to or less than a preset low reference illumination or a contrast recognizable reference illumination, prior to the execution of the self-correction mode.

20. The method according to 12, wherein the extracting of the one or more representative regions comprises checking a pre-stored history regarding extraction of representative regions for respective distances and extracting a representative region for a distance at a point of time when a preset reference time elapses.
